(19) United States
(12) Patent Application Publication
(10) Pub. No.: US 2005/0068986 A1
(43) Pub. Date: Mar. 31, 2005

(54) Universal switching centre, method for executing a switching task, input unit, output unit and connecting unit

(75) Inventors: Gert Eilenberger, Kirchheim (DE); Stephan Bunse, Stuttgart (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/949,204

(22) Filed: Sep. 27, 2004

(30) Foreign Application Priority Data
Sep. 30, 2003 (EP) 03 292 400.3
Jul. 17, 2004 (DE) 04 034 685.2

(51) Int. Cl. H04J 3/00

(52) U.S. Cl. 370/498; 370/466

(57) ABSTRACT

The invention relates to a universal switching centre for switching data streams, comprising a multiplicity of inputs, a multiplicity of outputs, and a switching network comprising a multiplicity of inputs, which are respectively connected, via an input unit, to one input out of the multiplicity of inputs of the universal switching centre, and a multiplicity of outputs, which are respectively connected, via an output unit, to one output out of the multiplicity of outputs of the universal switching centre, and having the switching network constructed as a synchronous time-division multiplex switching network, each input unit having means for adding to the data stream, prior to its distribution to time slots, information which, following the division of the data stream into data subpackets, enables these data subpackets to route themselves through the switching network, as well as to a switching centre, a method for executing a switching task, an input unit, an output unit and a connecting unit.

### TECHNICAL FIELD

The invention relates to a universal switching centre for switching data streams having a multiplicity of data formats, comprising a multiplicity of inputs, a multiplicity of outputs, and a switching network comprising a multiplicity of inputs, a method for executing a switching task in a switching centre comprising a multiplicity of inputs, a multiplicity of outputs, and a switching network comprising a multiplicity of inputs, an input unit comprising a multiplicity of inputs, a multiplicity of outputs, and a switching network comprising a multiplicity of inputs, an output unit comprising a multiplicity of inputs, a multiplicity of outputs and a connecting unit comprising a multiplicity of inputs, a multiplicity of outputs, and a switching network comprising a multiplicity of inputs. The invention is based on the priorities applications EP 03 292 400.3 and DE 04 034 685.2 which are hereby incorporated by reference.

### BACKGROUND OF THE INVENTION

The present worldwide telecommunications network is composed of a multiplicity of sub-networks, which operate with different formats and protocols. ISDN, SDH, IP, ATM and Ethernet are merely keyword examples that may be cited here. Possible connection types in this context are both switched connections and virtual connections, as well as individual datagrams with a complete address and data part.

Common to all of these is the fact that switching occurs in some form, i.e., that a data stream shares the physical network means with other data streams in respect of both sections and time, and that it is necessary to switch over between them. It is also precisely for this purpose that all of these many sub-networks are interconnected.

It is usual for each of these individual sub-networks to have its own switching facilities. Depending on the data format used in the respective sub-network, the terms switching centre, router or cross-connect may be used, for instance, the actual English terms being frequently used in, for example, a German context. The proportion of the traffic types in the total traffic, and consequently the proportion in individual sub-networks, fluctuates both in the short term (times of day and weekdays) and in the long term, due to technical development. In addition, there is a recurrent need not only to develop but also, in particular, to construct new sub-networks with new type of switching facilities.

The US patent application US 2002/0191588 A1 describes a switching system by means of which data packets, for the purpose of switching in a switching network, are divided up in such a way that they can be sent in periodically recurring time slots of fixed length. In that case, however, the division and the path of the data packets is controlled by an external control unit, this being both time-intensive and cost-intensive.

In the following, for reasons of simplification, the various formats, protocols or traffic types are referred to as transmission formats; the various switching facilities are referred to as a switching centre. All data which belong together and are treated equally within such a switching centre are referred to as a message; such a treatment is referred to as switching.

The invention is based on the object of remedying the situation described above.

### SUMMARY OF THE INVENTION

This object is achieved, according to the invention, by a universal switching centre for switching data streams having a multiplicity of data formats, comprising a multiplicity of inputs, a multiplicity of outputs, and a switching network comprising a multiplicity of inputs, which are respectively connected, via an input unit, to one input out of the multiplicity of inputs of the universal switching centre, and a multiplicity of outputs, which are respectively connected, via an output unit, to one output out of the multiplicity of outputs of the universal switching centre, and having the switching network constructed as a synchronous time-division multiplex switching network having a time-slot length of one byte or a few bytes, in which switching centre each input unit has means for having permanently or temporarily assigned to itself, in dependence on the format of the received data stream, one or more connections, each with at least one time slot, through the switching network to an output unit, in order to match the respective data stream to these connections, divide it up into the requisite time slots and send it, and in order to have assigned connections through the switching network cleared again, wherein each input unit has means for adding to the data stream, prior to its distribution to the time slots, information which, following the division of the data stream into data subpackets, enables these data subpackets to route themselves through the switching network, and each output unit has means for receiving data coming from such assigned connections and reprocessing it in dependence on the format of the received data stream and sending it at its output. This object is achieved, according to the invention, by a method for executing a switching task in a switching centre comprising a multiplicity of inputs, a multiplicity of outputs, and a switching network comprising a multiplicity of inputs, which are respectively connected, via an input unit, to one input out of the multiplicity of inputs of the switching centre, and a multiplicity of outputs, which are respectively connected, via an output unit, to one output out of the multiplicity of outputs of the switching centre, particularly in a universal switching centre according to claim 1, which switching centre comprises at least one connecting unit which can be accessed by at least a portion of the input units, which switching centre comprises at least one connecting unit from which at least a portion of the output units is accessible, in which switching centre that portion of the input units from which the connecting unit is accessible is of such design that it can forward portions of arriving data streams to the or a connecting unit, and in which switching centre the connecting unit is of such design that it can handle at least one format of arriving data streams such that these data streams are either switched to a further connecting unit, which is of such design that it can handle at least one format of arriving data streams such that these data streams are subsequently switched to those output units which are accessible from the further connecting unit, or they are switched directly to these output units, an input unit for a universal switching centre comprising a multiplicity of inputs, a multiplicity of outputs, and a switching network comprising a multiplicity of inputs, which are respectively connected, via an input unit, to one input out of the multiplicity of inputs of the universal switching centre, and a multiplicity of outputs, which are respectively connected, via an output unit, to one output out of the multiplicity of outputs of the universal switching centre, and having the switching network constructed as a synchronous time-division multiplex switching network having a time-slot length of one byte or a few bytes, in which switching centre each input unit has means for having permanently or temporarily assigned to itself one or more connections, each with at least one time slot, through the switching network to an output unit, in order to match the respective data stream to these connections in dependence on the format of the received data stream, divide it up into the requisite time slots and send it, and in order to have assigned connections through the switching network cleared again, wherein the input unit comprises means for matching the respective data stream to these connections in such a way that there is added to the data stream, prior to its distribution to the time slots, information which, following the division of the data stream into data subpackets, enables these data subpackets to route themselves through the switching network, an output unit for a universal switching centre comprising a multiplicity of inputs, a multiplicity of outputs, and a switching network comprising a multiplicity of inputs, which are respectively connected, via an input unit, to one input out of the multiplicity of inputs of the universal switching centre, and a multiplicity of outputs, which are respectively connected, via an output unit, to one output out of the multiplicity of outputs of the universal switching centre, and having the switching network constructed as a synchronous time-division multiplex switching network having a time-slot length of one byte or a few bytes, in which switching centre each input unit has means for having permanently or temporarily assigned to itself one or more connections, each with at least one time slot, through the switching network to an output unit, in order to match a data stream to these connections, divide it up into the requisite time slots and send it, and in order to have assigned connections through the switching network cleared again, wherein there is added to the data stream, prior to its distribution to the time slots, information which, following the division of the data stream into data subpackets, enables these data subpackets to route themselves through the switching network, and the output unit comprises means for receiving data subpackets arriving from such assigned connections and reprocessing them in dependence on the format of the received data stream and sending them at its output and a connecting unit for a switching centre comprising a multiplicity of inputs, a multiplicity of outputs, and a switching network comprising a multiplicity of inputs, which are respectively connected, via an input unit, to one input out of the multiplicity of inputs of the switching centre, and a multiplicity of outputs, which are respectively connected, via an output unit, to one output out of the multiplicity of outputs of the switching centre, particularly for a universal switching centre according to claim 1, which switching centre comprises at least one connecting unit which can be accessed by at least a portion of the input units, which switching unit comprises at least one connecting unit from which at least a portion of the output units is accessible, wherein the connecting unit is of such design that it can handle at least one format of arriving data streams such that these data streams are either switched to a further connecting unit and subsequently switched to those output units which are accessible from the further connecting unit, or they are switched directly to those output units which are accessible from the connecting unit or the first connecting unit.

The same switching centre is thus used for all transmission formats. In this case, all messages to be switched are divided up into units which are of the same length as each other, but are very short, preferably of the length of one byte. The switching unit is a synchronous time-division multiplex switching network suitable for switching such short units. The matching of the various transmission formats is performed peripherally, in suitable input and output units.

For transmission format matches which are particularly demanding of resources or for which there is little requirement, it is possible to connect to the switching network additional connecting units which can then be accessed in a more or less transparent manner from the input units, and which can then, in turn, also access the output units in a more or less transparent manner. Such connecting units are suitable for use not only in the case of the present universal switching centre, but also in the case of other types of switching centres, for instance, those which do not operate on a synchronous basis, or those which are not limited to short data units.

Since different sub-networks come together at such a switching centre, a network interface may easily be realized at this point, in that the function of a so-called gateway is included in the functions performed by the peripheral equipment of this switching centre, whether by an input unit, an output unit, a connecting unit or a combination thereof.

Further developments of the invention are disclosed by the sub-claims and the following description.

### BRIEF DESCRIPTION OF THE DRAWINGS

The invention is explained more fully in the following with reference to the accompanying drawings, wherein:

FIG. 1 shows an exemplary sequence of operations in an input unit according to the invention.

FIG. 2 shows a data packet structure for the example according to FIG. 1.

FIG. 3 shows an exemplary embodiment of a universal switching centre according to the invention.

FIG. 4 shows an exemplary embodiment of a connecting unit according to the invention.

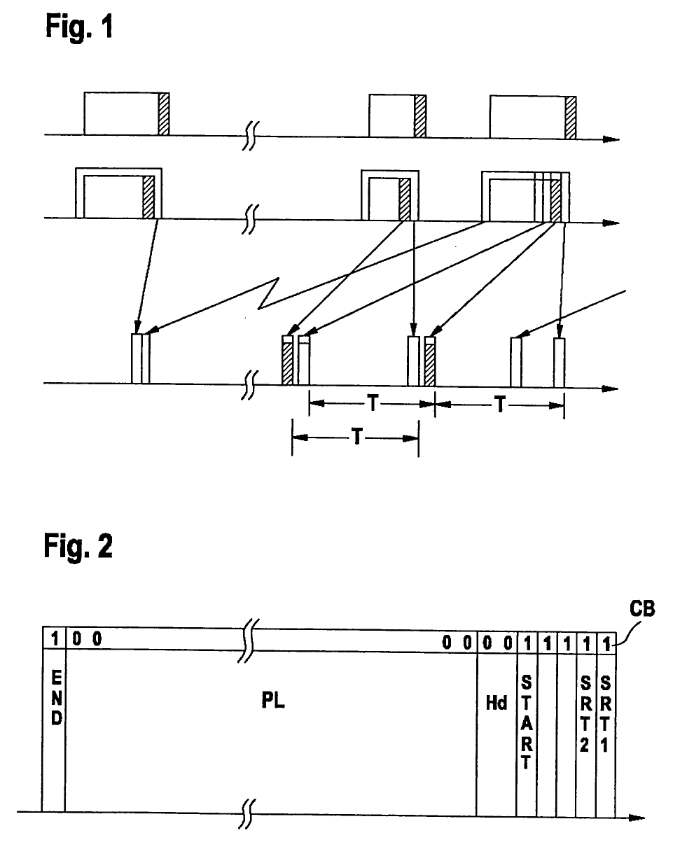

The basic concept underlying the invention is described first with reference to FIG. 1. For this purpose, reference is also made to the patent application EP 0 320 714 A2 and the corresponding U.S. Pat. No. 4,922,487, and to the content thereof.

### DETAILED DESCRIPTION OF PREFERRED EMBODIMENTS

The first line of FIG. 1 shows a data stream arriving at an input of a switching centre. A data stream of a fundamentally different structure may arrive at another input of the same switching centre. Respectively provided between the inputs of the switching centre and the inputs of the switching network are input units which, on the one hand, fulfil the transmission requirements and, on the other hand, effect matching to the internal format of the switching network. Only the matching to the internal format of the switching network is considered in greater detail here.

The data stream shown here consists of a sequence of data packets of differing length, between which there are pauses. The data packets are entirely asynchronous relative to one another. Each data packet has a packet header (shaded) and a payload (unshaded). The packet header may contain full address information, specifying the sender and the receiver; however, it may also contain a reference to a pre-set connection path. Both variants are generally known per se.

As shown by the second line of FIG. 1, this data stream is prepared for internal processing in the switching centre. For this purpose, as shown in greater detail by FIG. 2, additional information is added which renders possible processing within the switching network.

The third line then shows the data stream at the input of the switching network. Arrows represent the transition from the second line to the third line. Depending on the internal structure of the switching network, each data packet is now divided up into single data subpackets, which correspond to the time-slot length in the switching network. These data subpackets are then brought into such a synchronous time sequence that, within the data stream, they occur in equal time intervals of the length T. This length T is the frame length of all synchronous sequences within the switching network. To begin with, the first data subpacket of the first data packet is inserted in a free time slot of the output data stream of the input unit. The further data subpackets of this data packet are then inserted in this data stream at the interval of a frame length T. In between come data subpackets of preceding data packets. The same sequence is realized for all subsequent data packets.

In principle, it is also possible to allow more than one time slot to be allocated to a data packet within the frame length T, for large data packets, for instance. In the case of two time slots being allocated, all unevenly numbered data subpackets are then separated from one another by the interval T, as are all evenly numbered data subpackets. The second data subpacket follows the first at an interval which is less than T. The mean interval is thus T/2. The same applies in the case of more than two time slots being allocated.

It is assumed here that the output capacity of the input circuit is at least as large as the input capacity. Due to the additional information added upon the transition from the first line to the second line in FIG. 1, the resultant total payload information is greater than at the input. It is possible that there are gaps in the input data stream, resulting from the transmission, in which case no further measures of any kind need be taken. Sometimes it is also ensured, for other reasons, that the data stream density on a particular input line of a switching centre is less than on an input to the switching network; here, likewise, buffer memories may be necessary. Otherwise, there is either a need for appropriate division to several output data streams or the internal clock cycle must be higher.

FIG. 2 shows an exemplary data packet structure, such as that obtained in the second line in the example according to FIG. 1. PL denotes the actual payload. In this case, it is represented as a block of indeterminate length and of a width of one byte (8 bits). The width of 8 bits is obtained through serial-parallel conversion from the usually serially transmitted data stream. Normally, this also corresponds to a subdivided arrangement of the payload to be transmitted. Ultimately, however, this is immaterial; any other width is possible. In any case, this payload content must be forwarded without change, nor can its content be evaluated. This payload is also already contained in the first line in FIG. 1, although possibly in a different time scale.

Hd for “header” in FIG. 2 denotes a packet header. In the example shown, the header has a length of two bytes. Data packets are transmitted almost exclusively in a non-synchronous manner. This means, at least, that data packets belonging to the same message do not follow one another at uniform intervals in the entire data stream. The association of data packets with a message cannot therefore be identified from the chronological position in the data stream. This identification function is provided by the content of the packet header.

At least in those cases in which a single data packet per se already contains a complete message, and thus constitutes a so-called datagram, the packet header must contain at least a complete address of the receiver. In many other cases a message will consist of a multiplicity of data packets, or possibly a plurality of messages will be transmitted on a preset path from the same sender to the same receiver, for instance, during surfing of the Internet. In this case, it is sufficient if, at each point in the network, the packet header can be uniquely assigned to a particular transmission path out of a limited number of (virtual) transmission paths. In this case, as already stated, the transmission path must first be marked, an individual allocation of a transmission channel being effected on each transmission link. It is then sufficient if the respective assignment is specified in the packet header. However, the content of the packet header must then be translated at the boundary between two transmission links. In the example, this can be effected at the transition from the first to the second line in FIG. 1. In the case of the universal switching centre constructed according to the invention, no such addressing is required internally, in the switching network. It is therefore possible to enter already at this point the information for the transmission link following the switching centre. In this case, the translation can also be effected at the output of the switching network, i.e., in an output unit.

In addition, for the purpose of internal handling in the switching network, internally required information is now added to the payload PL and to the packet header Hd.

Shown first are two bytes SRT1 and SRT2, their function being internal path selection in the switching network. This example is based on a switching network in which the internal paths are not set by a central controller, but in which the message itself establishes its path. The two bytes SRT1 and SRT2 contain the control information required for this purpose; they are also termed self-routing tags.

The two bytes SRT1 and SRT2 are followed by two bytes, which are not of further interest here, or are also provided only as a reserve and are also not denoted, these bytes being in turn followed by a start marker START. This start marker START is followed by the packet header Hd and the payload PL. The end is identified by an end marker END.

Since the end of the packet must be identifiable in any case, the end marker END must always be identifiable as such in the data stream. In principle, however, one cannot preclude the occurrence, within the payload PL, of a byte having the same bit sequence as the end marker END. For this reason, there is in this case assigned to each byte a control bit CB which, in this instance, identifies all additionally occurring bytes with a “1”, while the bytes of the data packet itself are identified with a “0”.

Due to the fact that the cohesion of the individual data subpackets is broken down within the switching network, the connection of payload and address is also no longer identifiable within the switching network. The association of a data subpacket with a message must be realized in another manner. In this case, this is realized by the equal time intervals, of the length T. The switching network must therefore operate synchronously. The time-slot length within the resultant frame structure is then equal to one data subpacket.

The assignment provision, described with reference to FIG. 1, between a data packet at the input of an input unit and the data subpackets at the output of this input unit is unequivocal and reversible. The associated data subpackets of a data packet will also arrive again, in the same chronological arrangement, at an output of the switching network. In an output unit disposed in the latter, the assignment described with reference to FIG. 1 will then be reversed, so that the original data packets, usually with a translated packet header, will then reappear. There thus results the establishment of both an input unit and an output unit of a universal switching centre according to the invention.

FIG. 2 does not match FIG. 1, since there the part preceding the packet header is of the same size as the packet header. The absolute values, however, do not matter.

What is decisive in this case, however, is that the data subpackets according to FIG. 1, and thus the time-slot length within the switching network, are short. In the patent application EP 0 320 714 A2 and the corresponding U.S. Pat. No. 4,922,487 which have been referred to above, reference has already been made to an essential advantage of such short data subpackets. The memory resource requirement within the switching network can be drastically reduced, compared with other concepts. Due to the distribution of a data packet to a greater time interval, the capacity utilization of the switching network also becomes more even; blocking is reduced while the resource commitment remains the same. The disadvantage of the additional delay remains.

In the case of the present invention, however, there is another essential point. Exclusively very short data elements to be switched occur within the switching network. In such short data elements, however, it is possible ultimately to resolve each transmission format. A switching centre constructed thus can therefore be used for switching messages in any transmission format. The matching to these transmission formats is effected in the input and output units. Only the latter need be matched to the respective transmission format and, if necessary, developed for new transmission formats. In addition, the possibly required greater buffer memories are needed only at these input and output units. The operational flow of such input and output units can be program-controlled. The matching to other transmission formats can be effected by changing of the sequence program. Accordingly, the switchover between two transmission formats can be effected by switching over between two sequence programs.

A transmission format was described with reference to FIG. 1 in which single data packets of unequal length occur with intermediate transmission gaps. Another data format is, for example, a stream of SDH containers in an SDH data stream, for instance, in the STM-1 hierarchy. In this case, in an input unit, in a manner similar to the example according to FIG. 1, each container is then broken down into a multiplicity of successive sub-containers, to which a synchronous path through the switching network is then assigned and which in the latter are again switched-through in bytes. The associated sub-containers are then reassembled, in that output unit to which they have been switched-through, to form an SDH container.

A further transmission format that is possible, in principle, is a conventional, synchronous time-division multiplex format such as PCM 30/32.

It is possible, in principle, for such a universal switching centre to have exclusively input units and output units which are all constructed for or set to the same transmission format. A portion of the input and output units may then be used for remote traffic and another portion used for local traffic, and thereby also concomitantly assume, amongst other functions, the function of an add/drop multiplexer.

Another such universal switching centre can then be constructed or set, in a corresponding manner, exclusively for another transmission format. It can then assume, for example, the function of a cross-connect.

Usually, however, the individual sub-networks for the various transmission formats are not entirely spatially separate from one another. Instead, they are superposed on one another and the “switching centres” for the individual transmission formats assigned to the respective services are also frequently combined in respect of organization and, consequently, spatially. In addition, this is usually where interfaces, or “gateways”, between the different sub-networks are realized, where it is also necessary to effect conversion between the transition formats. In a universal switching centre according to the invention it is now possible to interface without difficulty between two such sub-networks. The gateway function can then be concomitantly performed either in the input unit concerned or in the output unit.

However, a universal switching centre according to the invention which performs a switching function for two or more such sub-networks is usually over-dimensioned for this task. A portion of this universal switching centre, for instance, between a input lines and a output lines, with a input units and a output units, and the intermediate portion of the switching network, with an a×a structure, is then used for the first sub-network. Another portion of this universal switching centre, for instance, between b input lines and b output lines, with b input units and b output units, and the intermediate portion of the switching network, with a b×b structure, is then used for the second sub-network. Overall, however, a switching network is required which has an N×N structure, N being at least equal to a+b. The interfaces between the a input lines and the b output lines, and between the b input lines and the a output lines, are equipped in exactly the same way as those from a to a or b to b. Normally, however, they are used only for the gateway function, which usually has a lesser capacity utilization.

In this example, however, the universal switching centre according to the invention offers advantages in any case if the two sub-networks are directed, in respect of their function, towards different users, such as business and private users, and the switching centre is thereby subjected to such fluctuations, in respect of time of day, that its overall load varies less than the load of the two sub-networks. When the capacity utilizations of the two-sub-networks breathe, then the networks as such can also breathe. In particular, the connecting lines between two switching centres can then carry the one traffic type for a time and the other traffic type for a time. This only requires the input units and output units to be switched over between the two traffic types or transmission formats and thereby assigned to the other sub-network.

As, in the last example to be described, daily fluctuations occur, so the capacity utilizations of different sub-networks vary in the course of longer periods of time, for instance, in the case of the introduction of new transmission formats. In the case of a universal switching centre according to the invention, the input and output units must simply then be gradually converted to the new transmission format, or be replaced by appropriate new units. The remainder, in particular, the switching network and its controller, can remain unchanged. The existence of an over-dimensioning per se can thus be more than justified.

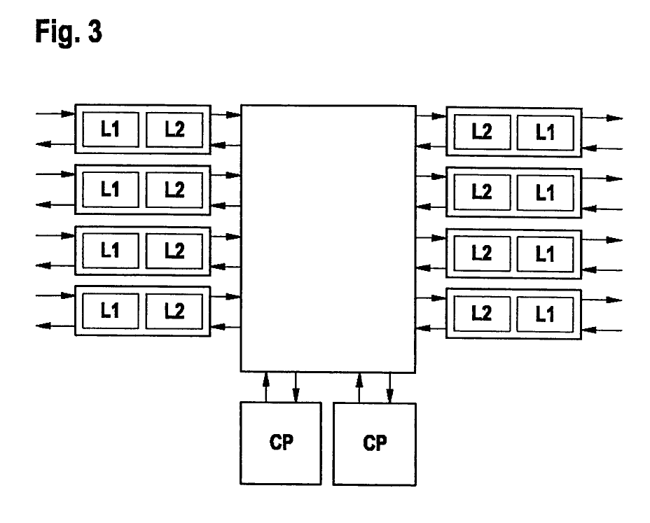

FIG. 3 shows an example of a complete universal switching centre which, in this representation, looks like any other switching centre. It has a core, the switching network, which is not indicated in greater detail in this case, and a series of line units connected to the latter. Additionally connected in this case are two central processing units CP. Both the line units and the central processing units are connected bi-directionally to the switching network. The line units also have bi-directional connections to the outside world, but the central processing units do not.

In principle, switching centres can also be represented in a unidirectional manner. The traffic flow is then usually represented from left to right, and each line unit is divided into an input unit, then disposed on the left, and an output unit, then disposed on the right. Additional units, such as the central processing units represented here, are then represented as feedback units between an output of the switching network on the right and an input of the coupling network on the left.

In this case, the line units are each divided into two blocks, denoted by L1 and L2. L1 and L2 stand, firstly, for “layer 1” and “layer 2” respectively. This is not intended to indicate anything concerning their structure, but only concerning their function. Different modules which are denoted in the same way may have different structures. In essence, the “layer 1” is responsible for the physical matching. This relates to quantities such an electrical or optical signal, signal level, clock rate, and the like. “Layer 2”, in essence, is responsible for the matching in respect of protocols. The latter, precisely in the case of the present universal switching centre, is not the same for all line units.

Central processing units such as those shown here can be used for various functions. Here, they are also intended to be used, according to the invention, as connecting units for relieving input or output units. In particular, transmission formats whose switching necessitates the buffering of relatively large quantities of data, or which necessitate the accessing of relatively large tables, or which are to be subjected to a gateway function, can be switched with the aid of such connecting units. For this purpose, that input unit reached by a data stream having this transmission format must forward this data stream in a largely transparent manner to such a connecting unit. The latter then, insofar as possible, assumes the function of an input unit and, if necessary, that of a gateway. The data packets are then sent out from the connecting unit, via the switching network, to a further connecting unit which, in this case, assumes the task of an output unit and, if necessary, that of a gateway. From here, they are then switched-through, again in a largely transparent manner, to an output unit. The two tasks, of the input unit and the output unit, may in this case also by assumed by a single connecting unit.

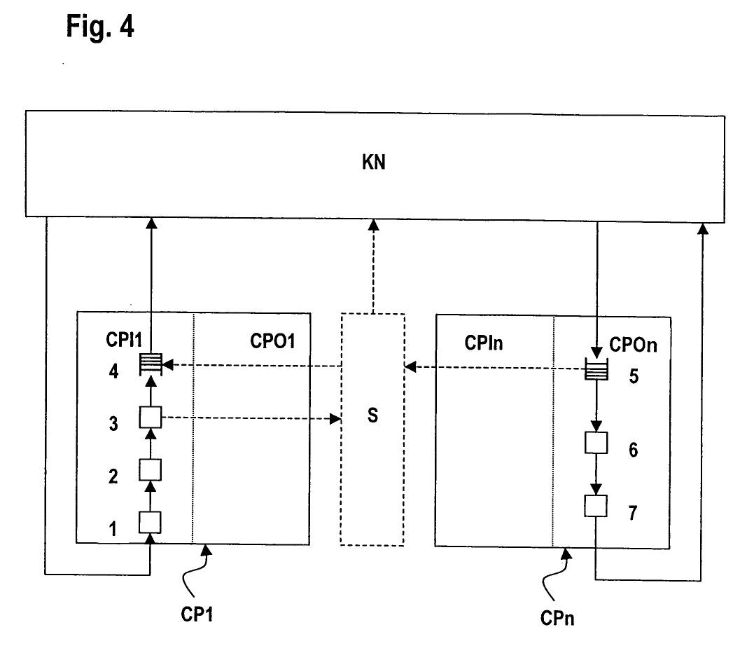

The course of the processing of the data streams in the connecting units can be described more precisely with reference to FIG. 4.

FIG. 4 shows a switching network KN and, exemplarily, a pair of connecting units CP1 and CPn of similar structure, which are connected to the switching network KN. The connecting units CP1 and CPn are in this case divided in respect of function into an input part CPI1 and CPIn respectively, and an output part CPO1 and CPOn respectively.

The input parts CPI1 and CPIn respectively have a defragmenting unit, denoted by 1, a deframing unit, which additionally breaks down the data packets and is denoted by 2, a routing table, denoted by 3, and a data buffer, denoted by 4. The output parts CPO1 and CPOn respectively, in turn, have a data buffer, denoted by 5, a framing unit, denoted by 6, and a unit for fragmenting by virtual concatenation, denoted by 7.

The inputs of the input parts CPI1 and CPIn respectively of the connecting units CP1 and CPn respectively are each connected to one of the outputs of the switching network KN, and the outputs of the input parts CPI1 and CPIn respectively of the connecting units CP1 and CPn respectively are each connected to one of the inputs of the switching network KN. The inputs of the output parts CPO1 and CPOn respectively of the connecting units CP1 and CPn respectively are each connected to one of the outputs of the switching network KN, and the outputs of the output parts CPO1 and CPOn respectively of the connecting units CP1 and CPn respectively are each connected to one of the inputs of the switching network KN.

In the event of the internal path of the data units through the switching network KN not being established by the message itself, this task is assumed by a central controller, the so-called scheduler S, which is shown together with its connections to the data buffer 4 and to the routing table 3 of the input part CPI1 of the connecting unit CP1, to the data buffer 5 of the output part CPOn of the connecting unit CPn and to the switching network KN.

An input unit sends a data stream via the switching network KN, in a largely transparent manner, to the input part CPI1 of the connecting unit CP1. If the data stream has been formed by the so-called principle of virtual concatenation, in which non-adjacent fragments of data structures such as, for example, fragments of so-called virtual containers in the case of SDH transmission, are combined to form a data stream, this virtual concatenation is first reversed in the defragmenting unit 1 and the associated fragments are assembled together.

Then, in the deframing unit 2, the frames of the data packets are broken down according to their structure such as, for example, GFP (generic framing procedure), Ethernet or ATM, into small data units of a size of, for example, one or a few bytes, as already mentioned in the description of the functionality of the input unit.

In the routing table 3, paths through the switching network, and output addresses which determine the further path of the data units following passage through the switching centre, are assigned to the input addresses of the individual data units.

If the internal path through the switching network KN is not established by the message itself, then the routing table 3 concomitantly provides the data units with information about this path, in the form of self-routing tags (SRT).

If the internal path through the switching network KN is defined by a so-called scheduler S, by means of a central controller, via an interface between the scheduler S and the switching network KN, the scheduler S must for this purpose obtain information about the routing from the routing table 3. In accordance with this information, the scheduler S switches the switching network KN, for the transmission of the individual data units, into the corresponding positions. The scheduler S is thus necessary for the establishment of a path through the switching network KN only if the path is not established by the message itself through self-routing tags (SRT).

The data buffer 4 is available for storage of the data units, and the sending of the data units through the switching network KN is centrally controlled by the scheduler S, via the interface between the scheduler S and the data buffer 4, if the path through the switching network KN is not established by the message itself through self-routing tags (SRT).

Following passage through the switching network KN, the individual data units reach the output part CPOn of the connecting unit CPn. Since the data rate at the input of the output part of this further connecting unit CPOn can be higher than the external data rate at the output of the switching centre, the arriving data units can first be buffered in the data buffer 5. If this data buffer 5 is in danger of overflowing, a situation can be achieved, by means of a so-called back pressure protocol, via the interface between the data buffer 5 of the output part CPOn of this connecting unit CPn and the scheduler S, whereby the scheduler S, via the interface to the data buffer 4 of the input part CPI1 of the first connecting unit CP1, reduces the data rate through the switching network KN. Without the scheduler S and back pressure protocol via the interface between the data buffer 5 and the scheduler S, it is necessary to accept the possibility of overflowing of the data buffer 5.

In order to obtain a data stream of a constant data rate, the data units are then subjected, in the framing unit 6, to a framing process such as, for example, GFP (generic framing procedure), Ethernet or ATM.

Then, in the fragmenting unit 7, the data streams are then combined through virtual concatenation on data paths according to their order, a combination of data streams of different orders such as, for example, VC4 and VC12 through virtual concatenation being inadmissible according to the standard.

The various data streams are thereupon sent, via the switching network KN, to the corresponding output units. For this purpose, the output part of the connecting units CPO1 and CPOn respectively has a switching functionality which controls where the various data streams are sent. Typically, an input part of a connecting unit CPI1 and CPIn respectively has a plurality of inputs, which can be connected to different input units, and an output part of a connecting unit CPO1 and CPOn respectively has a plurality of outputs, which can be connected to different output units. For reasons of simplification, only one input and one output respectively are shown in FIG. 4. The definition of a plurality of ports, i.e., output units, to which the data streams are to be sent is rendered possible by, for example, GFP (generic framing procedure). The corresponding outputs and ports to which the different data units are to be sent should in this case already be determined in the input unit CPI1 of the first connecting unit CP1, and stored in the routing table 3. A label containing the corresponding switching information is sent together with the data units and evaluated in the framing unit 6 during the framing process in the output unit CPOn of the connecting unit CPn. Although this procedure increases the overhead of the data units sent via the switching network, it does not require a second routing table in the output unit of the connecting unit CPOn, and is thus substantially less expensive.

Connecting units of the latter described type can also be used in the case of switching centres which are not constructed in the same way as the universal switching centre according to the invention described here.

1. Universal switching centre for switching data streams having a multiplicity of data formats, comprising a multiplicity of inputs, a multiplicity of outputs, and a switching network comprising a multiplicity of inputs, which are respectively connected, via an input unit, to one input out of the multiplicity of inputs of the universal switching centre, and a multiplicity of outputs, which are respectively connected, via an output unit, to one output out of the multiplicity of outputs of the universal switching centre, and having the switching network constructed as a synchronous time-division multiplex switching network having a time-slot length of one byte or a few bytes, in which switching centre each input unit has means for having permanently or temporarily assigned to itself, in dependence on the format of the received data stream, one or more connections, each with at least one time slot, through the switching network to an output unit, in order to match the respective data stream to these connections, divide it up into the requisite time slots and send it, and in order to have assigned connections through the switching network cleared again, wherein each input unit has means for adding to the data stream, prior to its distribution to the time slots, information which, following the division of the data stream into data subpackets, enables these data subpackets to route themselves through the switching network, and each output unit has means for receiving data coming from such assigned connections and reprocessing it in dependence on the format of the received data stream and sending it at its output.

2. Switching centre according to claim 1, wherein the input units and output units are of such construction that the handling of the data streams is largely program-controlled, and the matching to the format of the received data stream is effected through changing the program.

3. Switching centre comprising a multiplicity of inputs, a multiplicity of outputs, and a switching network comprising a multiplicity of inputs, which are respectively connected, via an input unit, to one input out of the multiplicity of inputs of the switching centre, and a multiplicity of outputs, which are respectively connected, via an output unit, to one output out of the multiplicity of outputs of the switching centre, particularly a universal switching centre according to claim 1, wherein the switching centre comprises at least one connecting unit which can be accessed by at least a portion of the input units, it comprises at least one connecting unit from which at least a portion of the output units is accessible, that portion of the input units from which the connecting unit is accessible is of such design that it can forward portions of arriving data streams to the or a connecting unit, and the connecting unit is of such design that it can handle at least one format of arriving data streams such that these data streams are either switched to a further connecting unit, which is of such design that it can handle at least one format of arriving data streams such that these data streams are subsequently switched to those output units which are accessible from the further connecting unit, or they are switched directly to these output units.

4. Method for executing a switching task in a switching centre comprising a multiplicity of inputs, a multiplicity of outputs, and a switching network comprising a multiplicity of inputs, which are respectively connected, via an input unit, to one input out of the multiplicity of inputs of the switching centre, and a multiplicity of outputs, which are respectively connected, via an output unit, to one output out of the multiplicity of outputs of the switching centre, particularly in a universal switching centre according to claim 1, which switching centre comprises at least one connecting unit which can be accessed by at least a portion of the input units, which switching centre comprises at least one connecting unit from which at least a portion of the output units is accessible, in which switching centre that portion of the input units from which the connecting unit is accessible is of such design that it can forward portions of arriving data streams to the or a connecting unit, and in which switching centre the connecting unit is of such design that it can handle at least one format of arriving data streams such that these data streams are either switched to a further connecting unit, which is of such design that it can handle at least one format of arriving data streams such that these data streams are subsequently switched to those output units which are accessible from the further connecting unit, or they are switched directly to these output units,
whereby the steps:
acceptance of a switching task by an input unit,
checking whether this switching task can be handled by this input unit,
handling of this switching task by this input unit if it is able so to do,
checking whether a connecting unit or a pair of connecting units is/are able to execute this switching task,
if so, forwarding of the switching task to the connecting unit or the first of the pair of connecting units,
handling of the first part of the switching task by the connecting unit or the first of the pair of connecting units and handling of the second part of the switching task by the connecting unit or the second of the pair of connecting units.

5. Input unit for a universal switching centre comprising a multiplicity of inputs, a multiplicity of outputs, and a switching network comprising a multiplicity of inputs, which are respectively connected, via an input unit, to one input out of the multiplicity of inputs of the universal switching centre, and a multiplicity of outputs, which are respectively connected, via an output unit, to one output out of the multiplicity of outputs of the universal switching centre, and having the switching network constructed as a synchronous time-division multiplex switching network having a time-slot length of one byte or a few bytes, in which switching centre each input unit has means for having permanently or temporarily assigned to itself one or more connections, each with at least one time slot, through the switching network to an output unit, in order to match the respective data stream to these connections in dependence on the format of the received data stream, divide it up into the requisite time slots and send it, and in order to have assigned connections through the switching network cleared again, wherein the input unit comprises means for matching the respective data stream to these connections in such a way that there is added to the data stream, prior to its distribution to the time slots, information which, following the division of the data stream into data subpackets, enables these data subpackets to route themselves through the switching network.

6. Output unit for a universal switching centre comprising a multiplicity of inputs, a multiplicity of outputs, and a switching network comprising a multiplicity of inputs, which are respectively connected, via an input unit, to one input out of the multiplicity of inputs of the universal switching centre, and a multiplicity of outputs, which are respectively connected, via an output unit, to one output out of the multiplicity of outputs of the universal switching centre, and having the switching network constructed as a synchronous time-division multiplex switching network having a time-slot length of one byte or a few bytes, in which switching centre each input unit has means for having permanently or temporarily assigned to itself one or more connections, each with at least one time slot, through the switching network to an output unit, in order to match a data stream to these connections, divide it up into the requisite time slots and send it, and in order to have assigned connections through the switching network cleared again, wherein there is added to the data stream, prior to its distribution to the time slots, information which, following the division of the data stream into data subpackets, enables these data subpackets to route themselves through the switching network, and the output unit comprises means for receiving data subpackets arriving from such assigned connections and reprocessing them in dependence on the format of the received data stream and sending them at its output.

7. Connecting unit for a switching centre comprising a multiplicity of inputs, a multiplicity of outputs, and a switching network comprising a multiplicity of inputs, which are respectively connected, via an input unit, to one input out of the multiplicity of inputs of the switching centre, and a multiplicity of outputs, which are respectively connected, via an output unit, to one output out of the multiplicity of outputs of the switching centre, particularly for a universal switching centre according to claim 1, which switching centre comprises at least one connecting unit which can be accessed by at least a portion of the input units, which switching unit comprises at least one connecting unit from which at least a portion of the output units is accessible, wherein the connecting unit is of such design that it can handle at least one format of arriving data streams such that these data streams are either switched to a further connecting unit and subsequently switched to those output units which are accessible from the further connecting unit, or they are switched directly to those output units which are accessible from the connecting unit or the first connecting unit.

8. Method according to claim 4, wherein the forwarding of the data streams away from the connecting units is controlled by an external control unit.

9. Method according to claim 8, wherein the data rate of the data stream sent by a connecting unit is controlled by the receiving connecting unit by means of the external control unit.
